(19) United States
(12) Patent Application Publication
(10) Pub. No.: US 2016/0093985 A1
(43) Pub. Date: Mar. 31, 2016

(54) HIGH SPEED HIGH DENSITY CONNECTOR ASSEMBLY

(71) Applicant: FOXCONN INTERCONNECT TECHNOLOGY LIMITED, Grand Cayman (KY)

(72) Inventors: YUAN ZHANG, Rowland-Heights, CA (US); AN-JEN YANG, Irvine, CA (US); JIE ZHENG, Rowland-Heights, CA (US); DE-CHENG ZOU, Monterey Park, CA (US); JUN-BIN HUANG, Eastvale, CA (US); PEI TSAO, Pomona, CA (US); JIM ZHAO, Irvine, CA (US)

(21) Appl. No.: 14/869,945

(22) Filed: Sep. 29, 2015

Related U.S. Application Data
(60) Provisional application No. 62/056,634, filed on Sep. 29, 2014.

(51) Int. Cl. H01R 13/6594; H01R 43/20

(52) U.S. Cl. CPC H01R 13/6594; H01R 43/205

(57) ABSTRACT

An electrical connector assembly includes plural wafers and the corresponding shielding plates are alternately stacked with one another. Each wafer includes a conductive housing defining plural slots therein, and plural terminal modules received in the corresponding slots, respectively. Each of the terminal modules includes a pair of differential contacts and an insulative holder retaining the pair of differential contacts. A plurality of cable assemblies correspond to the corresponding wafers. Each cable assemblies includes a plurality of cables each including a pair of differential wires respectively connected to the pair of differential contacts, respectively.

### CROSS-REFERENCE TO RELATED APPLICATIONS

This patent application is related to a U.S. patent application Ser. No. 13/772,232 filed Feb. 20, 2013 and entitled “HIGH SPEED HIGH DENSITY CONNECTOR ASSEMBLY”.

### BACKGROUND OF THE INVENTION

1. Field of the Invention

The present invention relates to a high speed high density connector assembly, and more particularly, to a high speed high density connector assembly having stacked contact wafers that are completely shielded.

2. Description of the Prior Art

Many prior art references disclose high speed high density connector assemblies with shielding structures. U.S. Pat. No. 6,709,294 B1, issued to Cohen et al. on Mar. 23, 2004, discloses an electrical connector having electrical conductors in a plurality of rows. Each of the plurality of rows includes a housing and a plurality of electrical conductors. Each electrical conductor has a first contact end connectable to a printed circuit board, a second contact end, and an intermediate portion therebetween that is disposed within the housing. The housing includes a first region surrounding each of the plurality of electrical conductors, the first region made of insulative material and extending substantially along the length of the intermediate portion of the electrical conductors. The housing also includes a second region adjacent the first region and extending substantially along the length of the intermediate portion of the electrical conductors. The second region is made of a material with a binder containing conductive fillers providing shielding between signal conductors. Furthermore, in discussing background art in U.S. Pat. No. 6,709,294, it is mentioned that a solution is introduced to provide shields through plastics coated with metals, but there are no combination of readily available and inexpensive metals and plastics that can be used, such as the plastic lacks desired thermal or mechanical properties, available plating techniques are not selective, etc.

U.S. Pat. No. 6,471,549 B1, issued to Lappohn on Oct. 29, 2002, discloses a shielded plug-in connector. The plug-in connector has a jack-in-blade strip having at least one first contact element and an edge connector having at least one second contact element corresponding to the first contact element. The edge connector, on or in its outer body areas, has at least partially shielding sheets. Shielding of the plug-in connector is achieved by, in addition to the shielding sheets provided on the edge connector, a shielding group with at least one first element arranged in the jack-in-blade strip. The first element of the shielding group is a base part in the form of a U-shaped rail. The shielding sheets on the edge connector have a planar body and angled stays. Two of the angled stays and a portion of the planar body between the two angled stays form a counterpart to the base part, wherein the counterpart and the base part together substantially encapsulate the first and second contact elements.

U.S. Pat. No. 7,581,990 B2, issued to Kirk et al. on Sep. 1, 2009, discloses a waferized electrical connector incorporating electrically lossy material selectively positioned to reduce crosstalk without undesirably attenuating signals. Wafer may be formed in whole or in part by injection molding of material to form its housing around a wafer strip assembly. A two shot molding operation may be adopted, allowing the housing to be formed of two types of material having different material properties, namely an insulative portion being formed in a first shot and lossy portion being formed in a second shot. The housing may include slots that position air, or create regions of air, adjacent signal conductors in order to provide a mechanism to de-skew a differential pair of signal conductors.

### OBJECTS OF THE INVENTION

A main object of the present invention is to provide a high speed high density electrical connector assembly with a cable assembly extension rather than the contact tails used for mounting to a printed circuit board.

The present invention first provides an electrical connector comprising a plurality of wafers and a plurality of shielding plates alternative arranged and stacked with each other in a transverse direction. Each of the wafers further comprises a conductive housing and a plurality of terminal modules. The conductive housing having opposite first and second faces both spanning perpendicular to the transverse direction, the first face defining a plurality of slots therein. Each of the terminal modules is received in one of the slots, each terminal module comprising an insulating holder and a pair of contacts extending along a signal path, each of said contacts having a contacting portion, a tail portion, and an intermediate portion connecting the contacting portion and the tail portion, the intermediate portions of the contacts in each pair being parallel fixed in the insulating holder and kept isolated from each other. A plurality of cables are connected to the corresponding terminal modules, respectively. Each of the cables includes a pair of differential wires and a drain wire wherein the differential wires are mechanically and electrically connected to the pair of contacts while the drain wire is mechanically and electrically connected to the shielding plate.

The present invention secondly provides a contact wafer adapted for an electrical connector. The contact wafer comprises a conductive housing, plural insulating holders, and plural pairs of contacts. The conductive housing defining plural slots in a side face, the plural slots extending along parallel paths from a first edge to a second edge in the side face. The plural insulating holders are received in the slots, respectively. The plural pairs of contacts are adapted to transfer the differential signal, each pair of the contacts extending along the path of a corresponding slot and kept isolated from the conductive board by a corresponding insulating holder. The conductive housing is formed by a molded plastic coated with metal plating or by die-casting.

### BRIEF DESCRIPTION OF THE DRAWINGS

The features of this invention which are believed to be novel are set fourth with particularity in the appended claims. The invention, together with its objects and the advantages thereof, may be best understood by reference to the following description taken in conjunction with the accompanying drawings, in which like reference numerals identify like elements in the figures and in which:

FIG. 1(A) is a front downward assembled perspective view of a connector assembly of according to a first embodiment of the present invention;

FIG. 1(B) is a rear upward assembled perspective view of the connector assembly of FIG. 1(A);

FIG. 2(A) is a front downward exploded perspective view of the connector assembly of FIG. 1(A);

FIG. 2(B) is a rear upward exploded perspective view of the connector assembly of FIG. 1(A);

FIG. 3 is a further front downward exploded perspective view of the connector assembly of FIG. 2(A);

FIG. 4(A) is a further front downward exploded perspective view of the connector assembly of FIG. 3;

FIG. 4(B) is a further rear downward exploded perspective view of the connector assembly of FIG. 3;

FIG. 5(A) is a front downward assembled perspective view of a connector assembly of according to a second embodiment of the present invention;

FIG. 5(B) is a rear upward assembled perspective view of the connector assembly of FIG. 5(A);

FIG. 6(A) is a front downward exploded perspective view of the connector assembly of FIG. 5(A);

FIG. 6(B) is a rear upward exploded perspective view of the connector assembly of FIG. 5(A);

FIG. 7 is a further front downward exploded perspective view of the connector assembly of FIG. 6(A);

FIG. 8(A) is a further front downward exploded perspective view of the connector assembly of FIG. 7;

FIG. 8(B) is a further rear downward exploded perspective view of the connector assembly of FIG. 7;

FIG. 9(A) is a front downward assembled perspective view of a connector assembly of according to a third embodiment of the present invention;

FIG. 9(B) is a rear upward assembled perspective view of the connector assembly of FIG. 9(A);

FIG. 10(A) is a front downward exploded perspective view of the connector assembly of FIG. 9(A);

FIG. 10(B) is a rear upward exploded perspective view of the connector assembly of FIG. 9(A);

FIG. 11 is a further front downward exploded perspective view of the connector assembly of FIG. 10(A);

FIG. 12(A) is a further front downward exploded perspective view of the connector assembly of FIG. 11;

FIG. 12(B) is a further rear downward exploded perspective view of the connector assembly of FIG. 11;

FIG. 13 shows the first step of assembling the first embodiment of FIG. 1(A)-4(B);

FIG. 14 shows the second step of assembling the first embodiment of FIG. 1(A)-4(B);

FIG. 15 shows the third step of assembling the first embodiment of FIG. 1(A)-4(B);

FIG. 16 shows the fourth step of assembling the first embodiment of FIG. 1(A)-4(B);

FIG. 17 shows the fifth step of assembling the first embodiment of FIG. 1(A)-4(B);

FIG. 18 shows the sixth step of assembling the first embodiment of FIG. 1(A)-4(B);

FIG. 19 shows the seventh step of assembling the first embodiment of FIG. 1(A)-4(B);

FIG. 20 shows the eighth step of assembling the first embodiment of FIG. 1(A)-4(B);

FIG. 21 shows the ninth step of assembling the first embodiment of FIG. 1(A)-4(B);

FIG. 22 shows the first step of assembling the second embodiment of FIG. 5(A)-8(B);

FIG. 23 shows the second and third steps of assembling the second embodiment of FIG. 5(A)-8(B);

FIG. 24 shows the fouth step of assembling the second embodiment of FIG. 1(A)-4(B);

FIG. 25 shows the third embodiment of FIG. 9(A)-12(B);

### DETAILED DESCRIPTION OF THE INVENTION

Reference will now be made to the drawing figures to describe the present invention in detail.

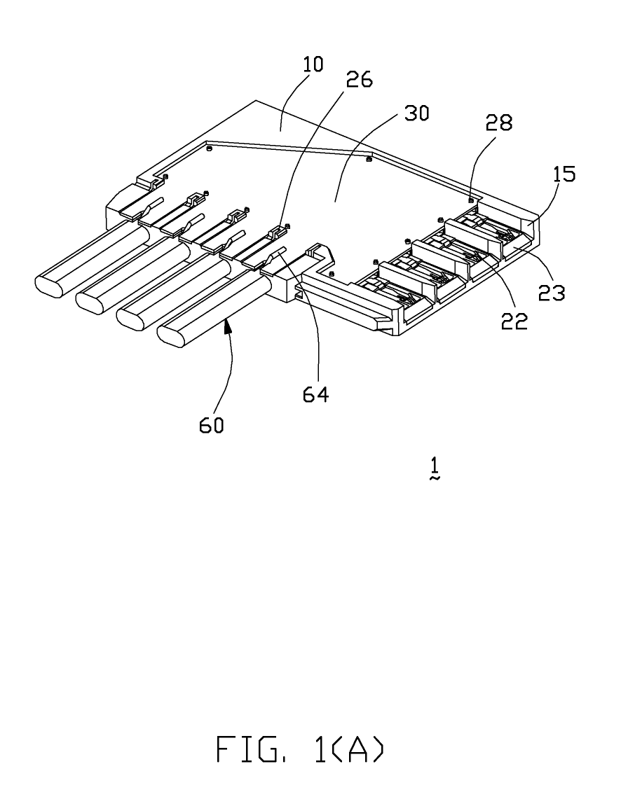

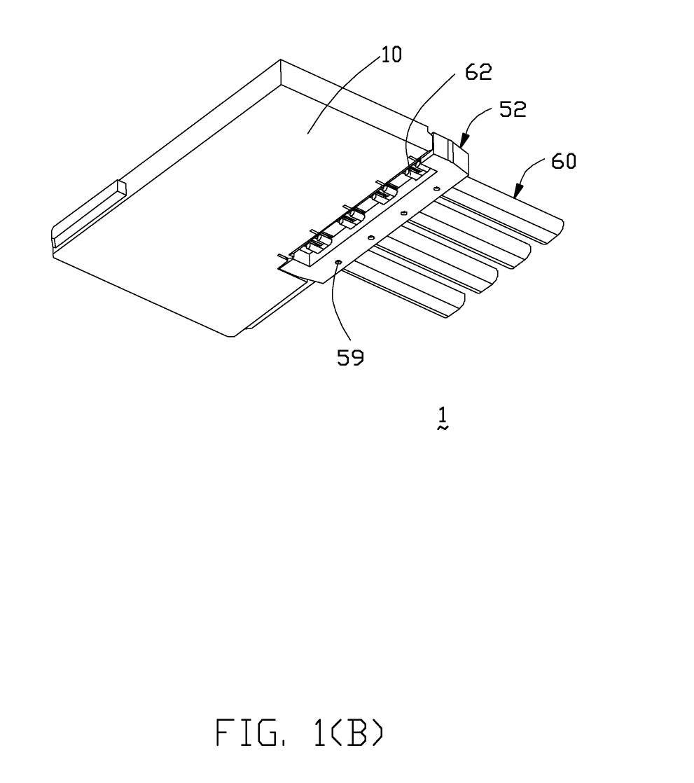

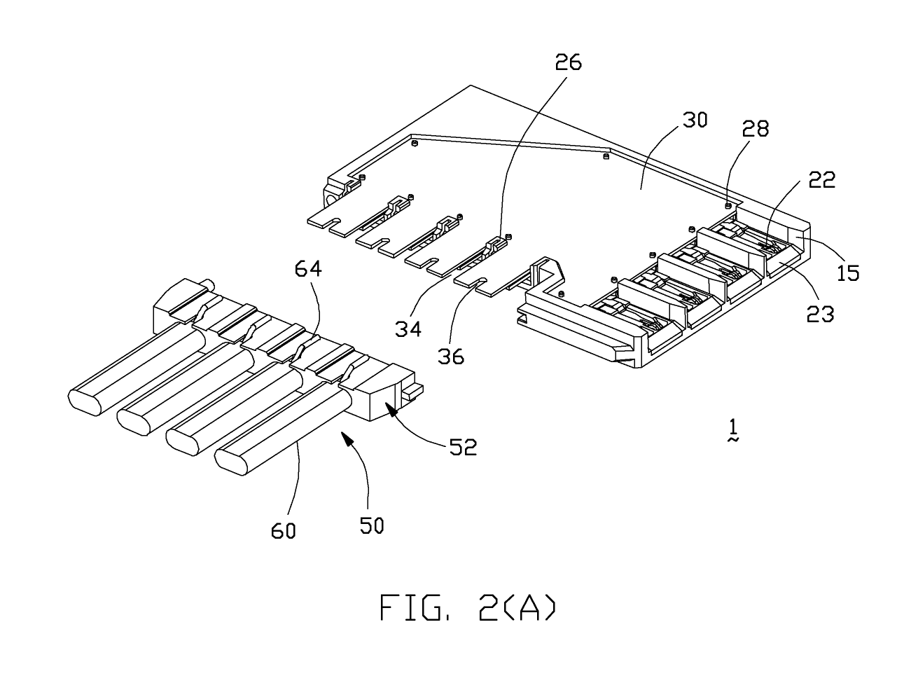

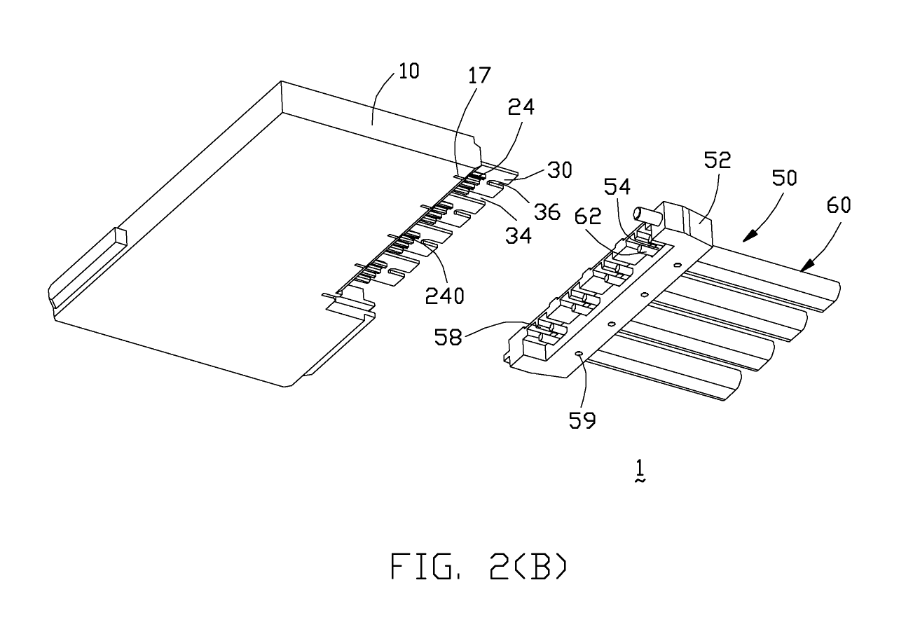

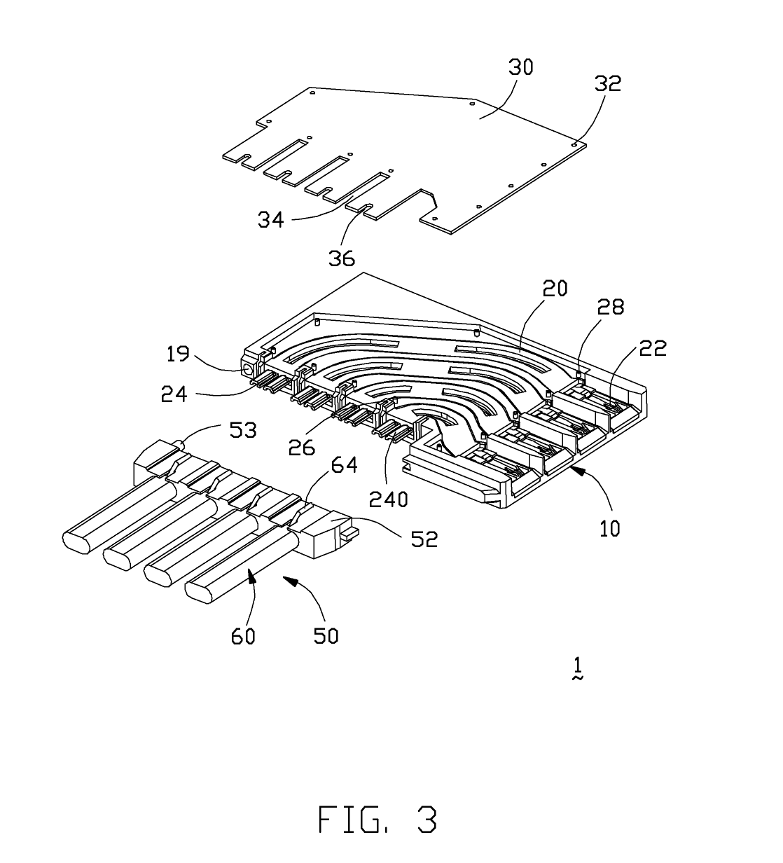

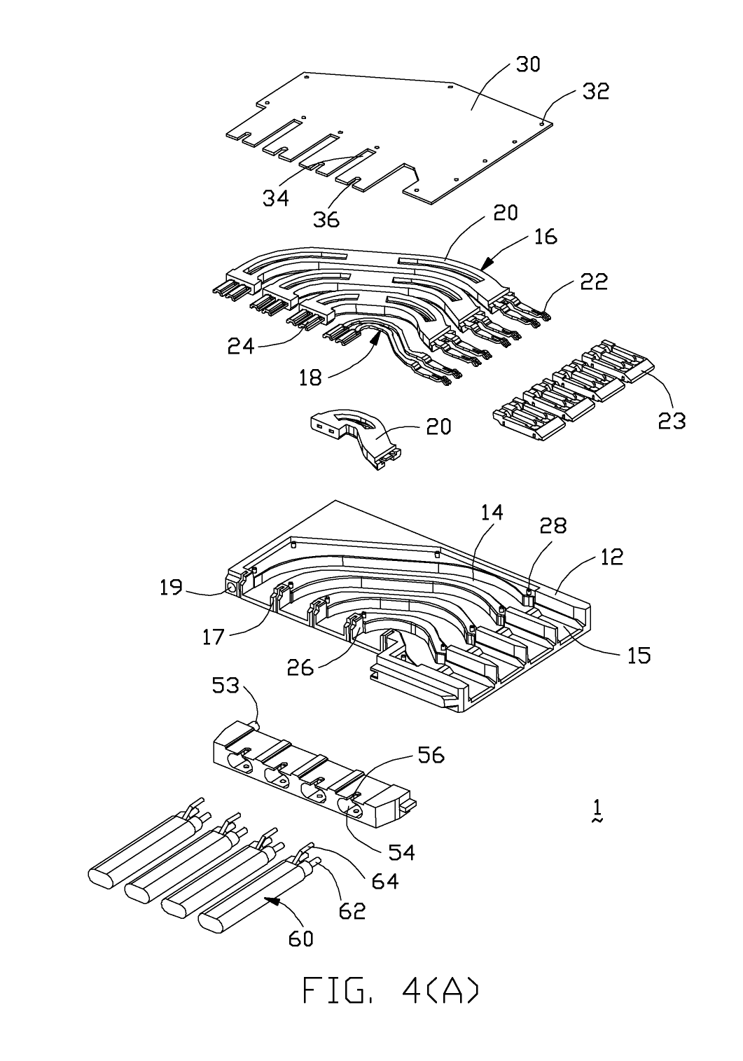

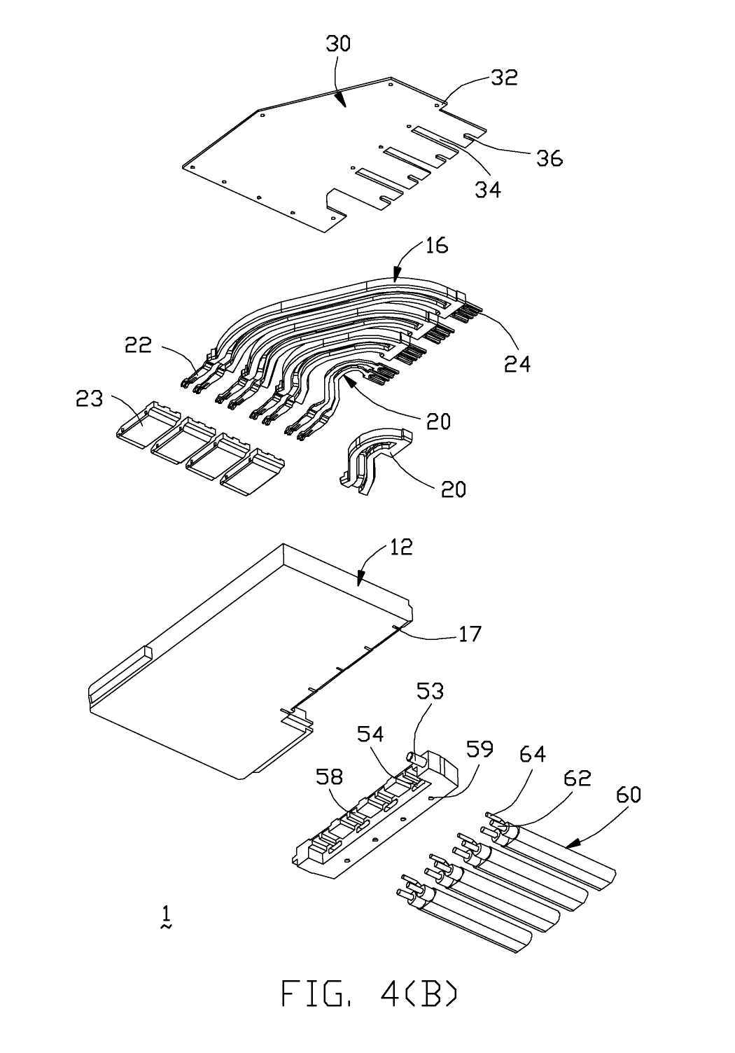

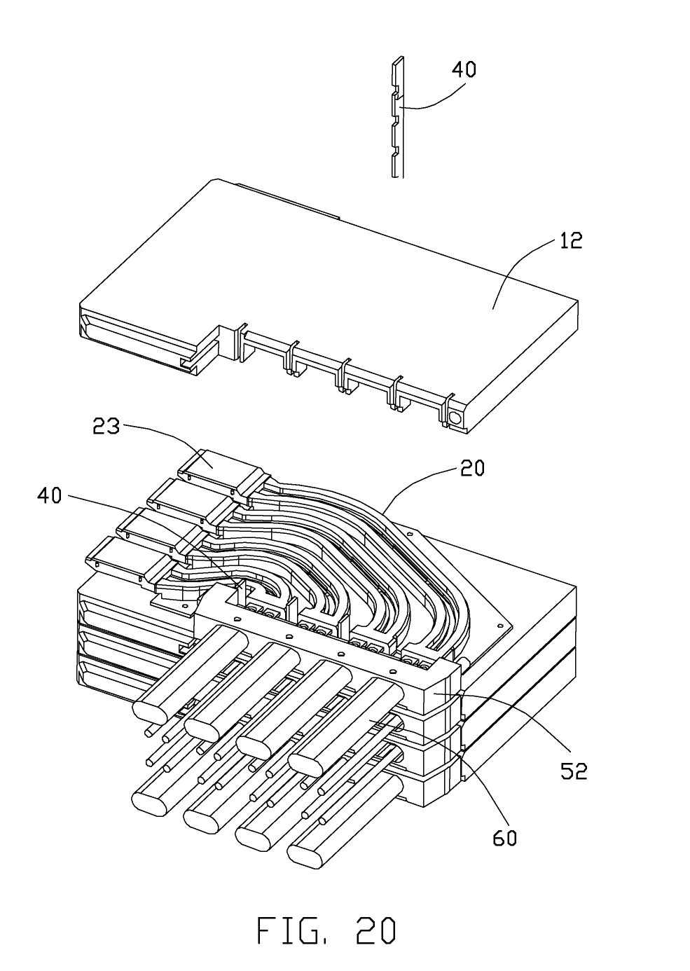

Referring to FIGS. 1(A)-4(B), the connector assembly 1 includes a plurality of wafers 10 (only one shown) and a plurality of metallic shielding plates 30 (only one shown) alternatively arranged and stacked with one another along a transverse direction. Each wafer 10 includes a conductive housing 12 which is either made of metal or plastic coated with metal, and a plurality of slots 14 formed in the housing 12 and extending in essentially a parallel relation with one another. A plurality of cavities 15 are formed in the housing 12 and in front of the corresponding slots 14 in a front-to-back direction. A plurality of terminal modules 16 is received in the corresponding slots 14, respectively, and each of the terminal module 16 includes a pair of differential contacts 18 enclosed within an insulative holder 20 wherein the insulative holder 20 is compliantly configured and snugly received in the corresponding slot 14. Each of the contacts 18 includes a front contacting section 22 for mating with a header connector, and a rear tail section 24 for connecting to a cable 60 (illustrated later). Each of the rear tail section 24 defines a pre-tined portion 240 for cable placement & soldering. The housing 12 further forms a plurality of retention blocks 26 defining slits 17 to receive shielding blades 40 (not shown in FIGS. 1(A)-4(B) but in FIG. 20) therein. A plurality of retainers 23 are received in the corresponding cavities 15 each to receive the contacting sections 22 of the pair of differential contacts 18.

The shielding plate 30 is assembled to the housing 12 via pegs 28 of the housing 12 and apertures 32 of the shielding plate 30. The shielding plate 30 forms a plurality of grooves 34 to receive the corresponding retention blocks 26 and a plurality of notch 36 to receive the corresponding drain wires 64 (illustrated later).

A plurality of cable assemblies (only one shown) 50 each corresponds to the paired wafer 10 and shielding plate 30. Each cable assembly 50 includes a spacer 52 and a plurality of cables 60 mounted thereon. The spacer 52 forms a plurality of passages 54, a plurality of recesses 56 communicating with the corresponding passages 54 respectively, a plurality of alignment slots 58 communication with the corresponding passages 54 for the rear tail section 24 alignment, and a plurality of inspection holes 59 communication with corresponding passages 54. The inspection holes 59 also can be used as pockets for glue which is applied to the passages 54. The spacer 52 forms a post 53 to be received in a hole 19 of the housing 12. Each cable 60 includes a pair of differential wires 62 and a drain wire 64 wherein the differential wires 62 extending through the corresponding passage 54, are mechanically and electrically connected to the tail sections 24 of the corresponding differential contacts 18 while the drain wire 64 extending through the corresponding recess 56 is mechanically and electrically received within the corresponding notch 36 and connected to the shielding plate 30. The shielding blades 40 are disposed between adjacent two pair of differential wires 62, respectively.

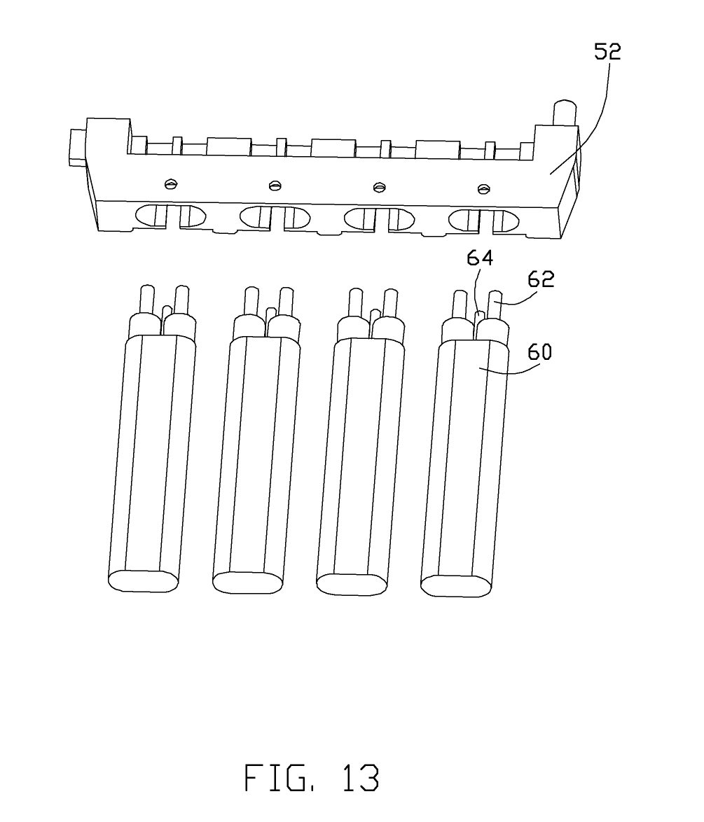

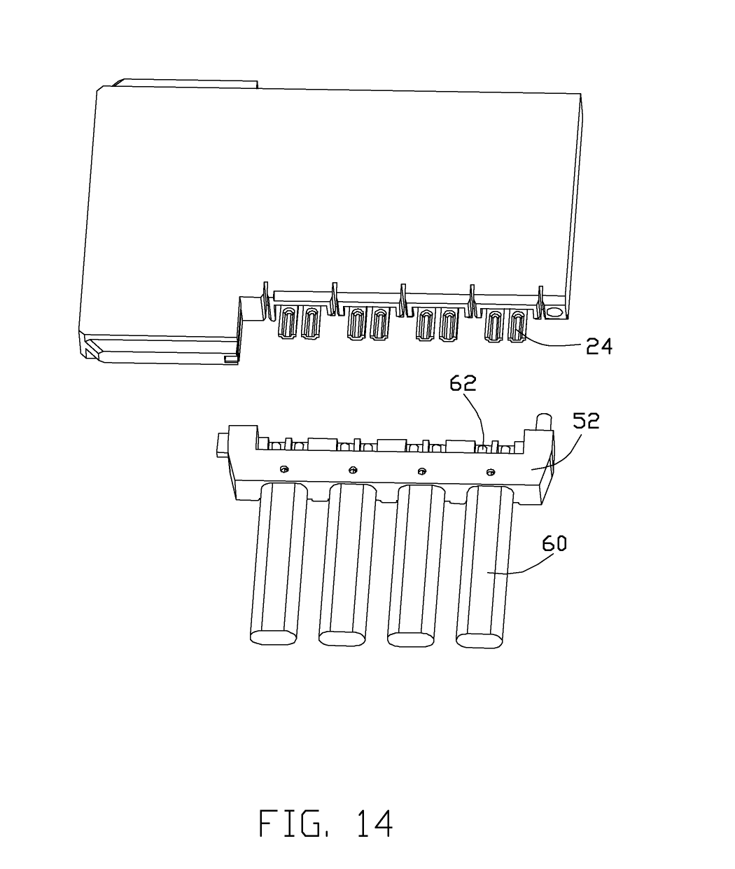

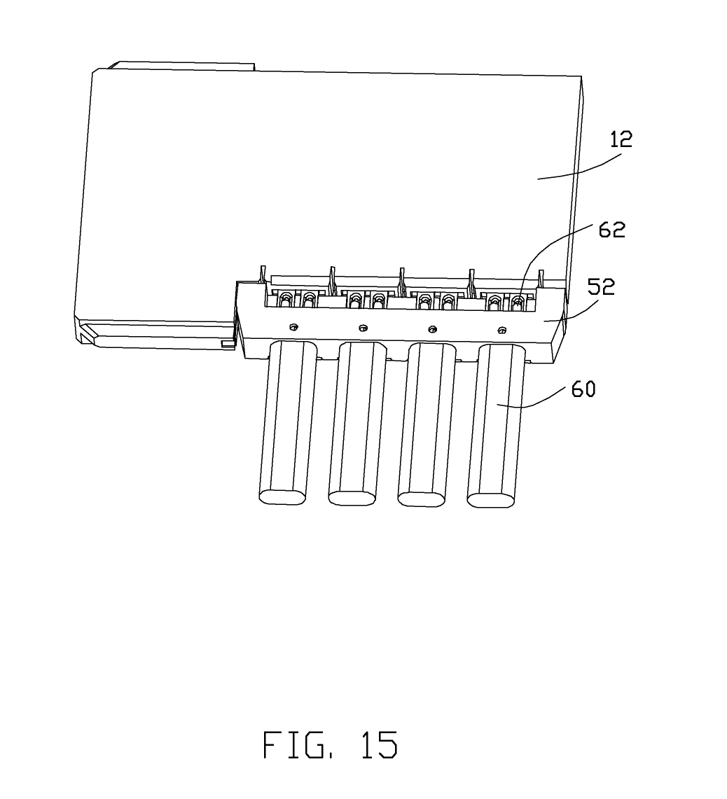

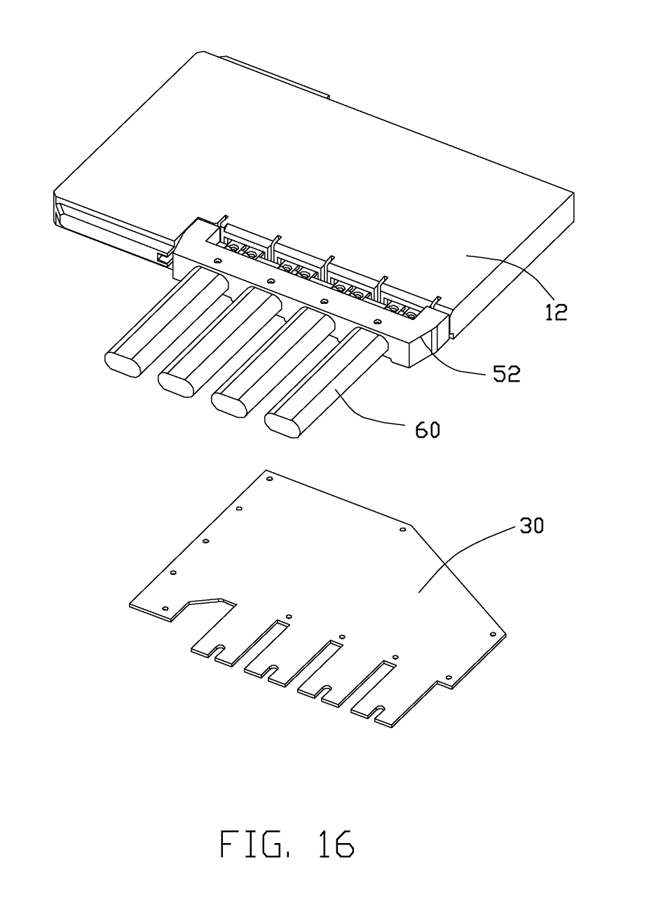

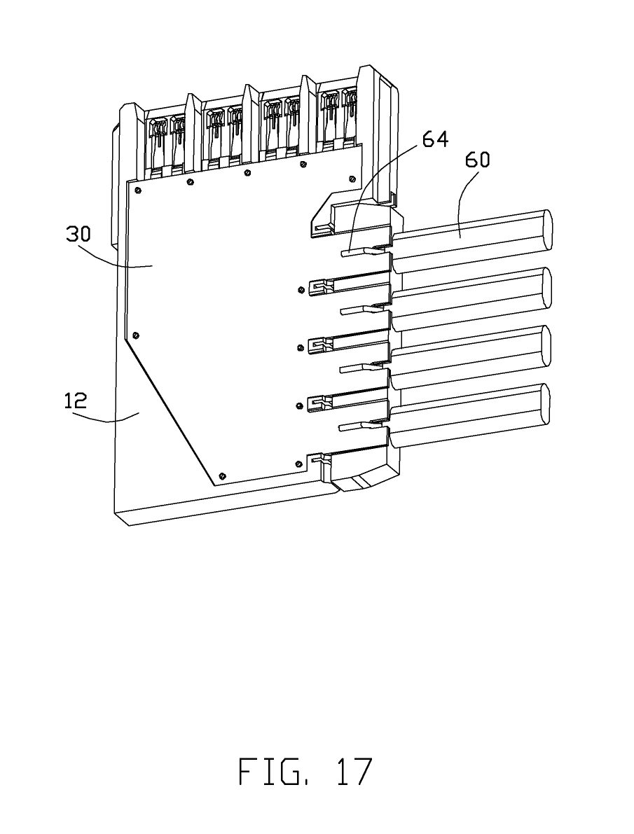

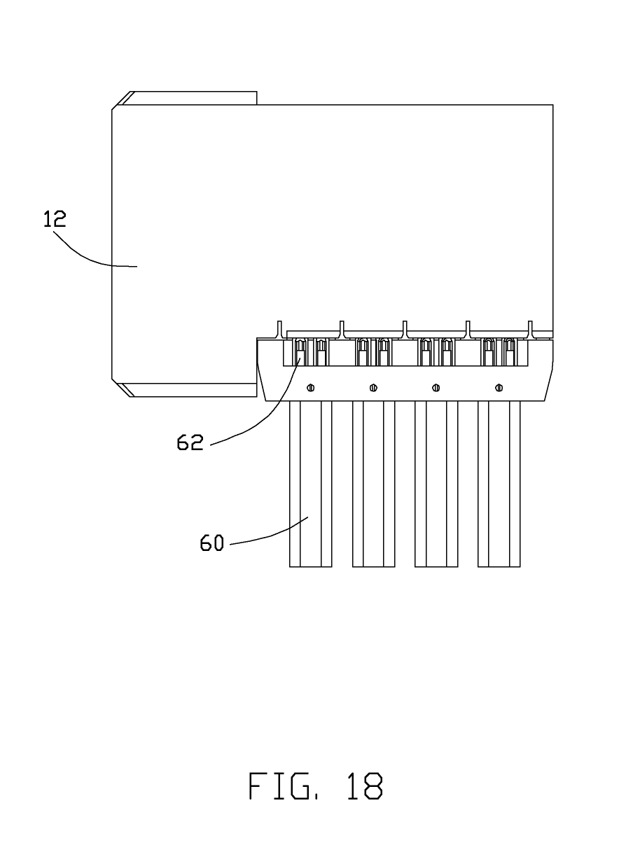

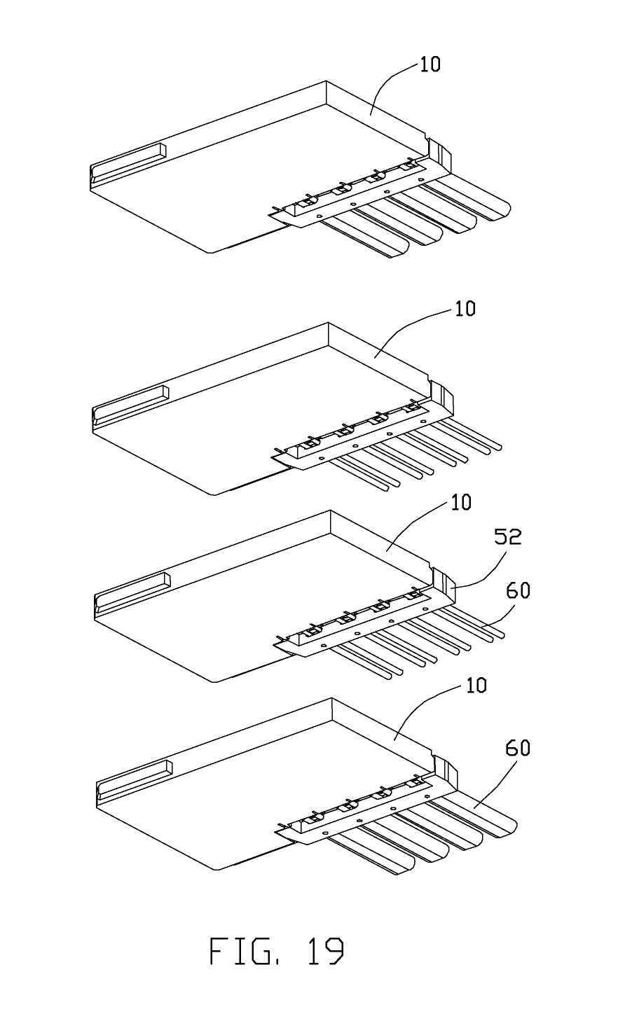

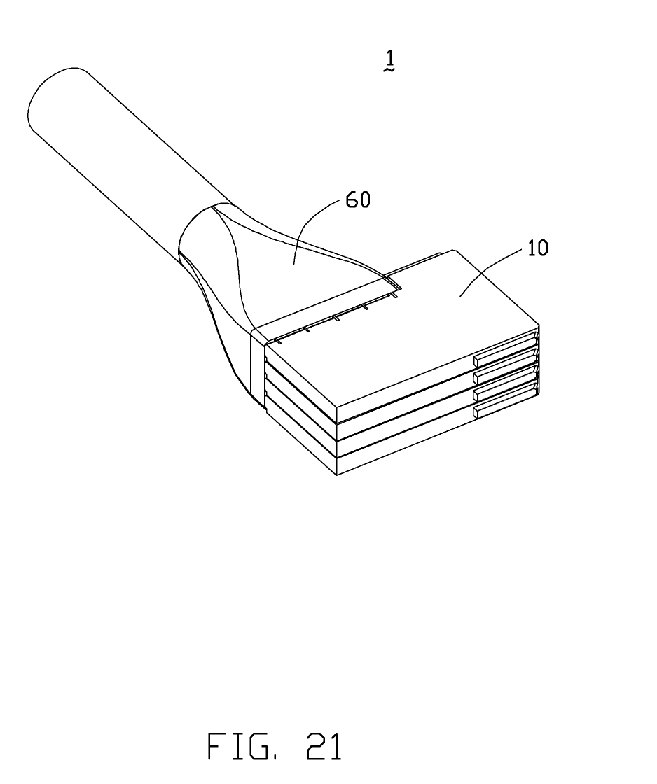

Referring to FIGS. 13-21, the assembling procedure includes:
Step 1: inserting the cable 60 into spacer 52 and applying glue;
Step 2: assembling the spacer 52 with the housing 12 and aligning the rear tail sections 24 with the passage 54 in the spacer 52 through the alignment slots 58;
Step 3: soldering the differential wires 62 to the rear tail sections 24;
Step 4: assembling the shielding plate 30 to the housing 12;
Step 5: soldering the drain wires 64 to the shielding plate 30;
Step 6: applying the hot glue to the solder joints;
Step 7: combining the wafers 10 together in the transverse direction;
Step 8: inserting the shielding blades 40 between the differential wires 62 in the transverse direction; and
Step 9: bundling the cables 60 together.

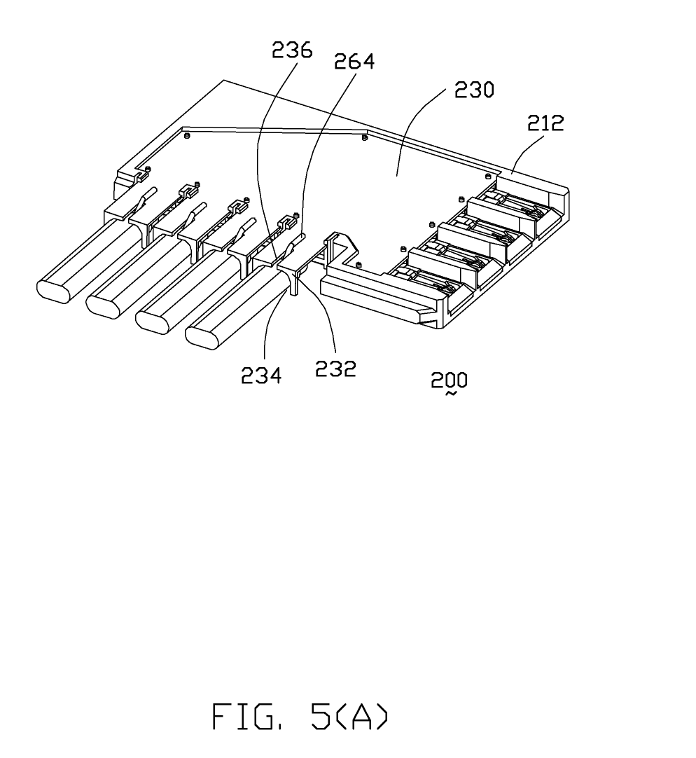

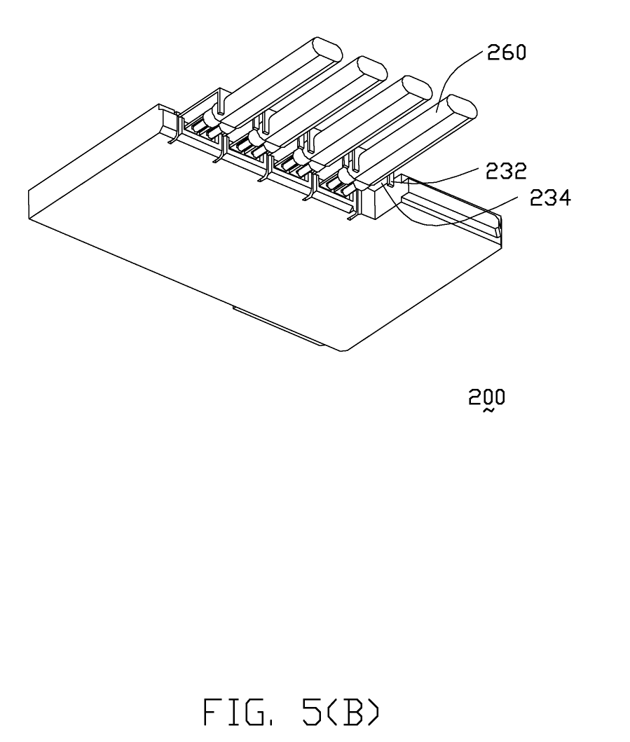

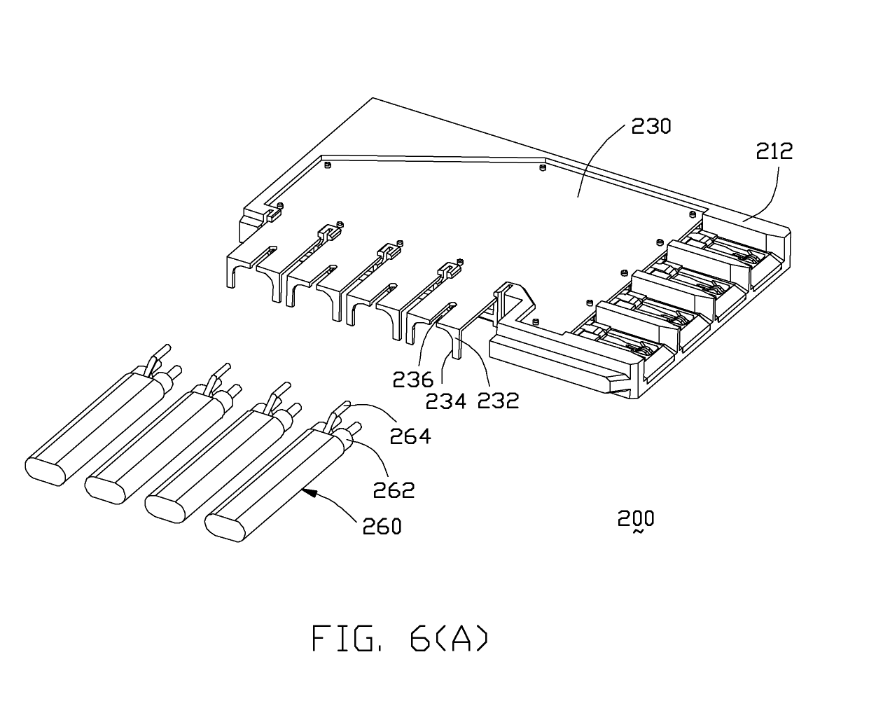

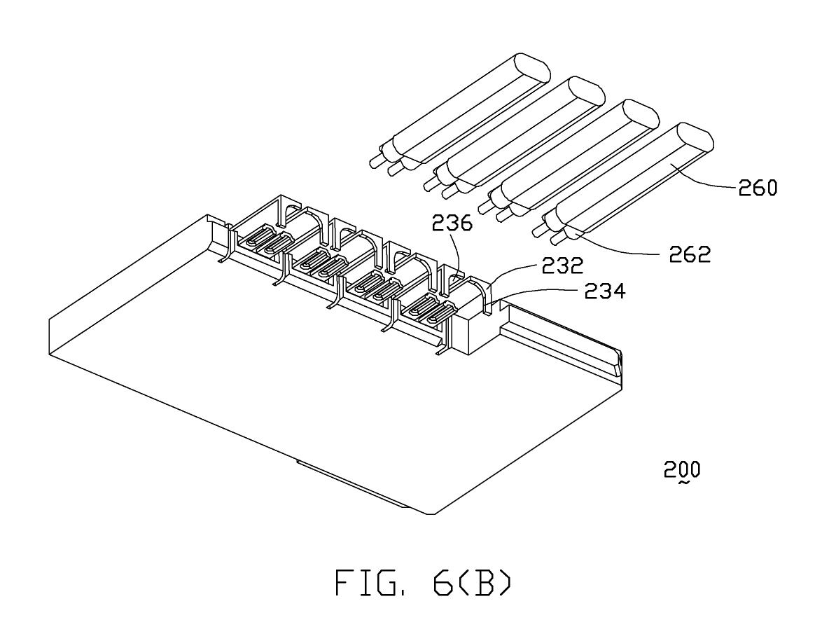

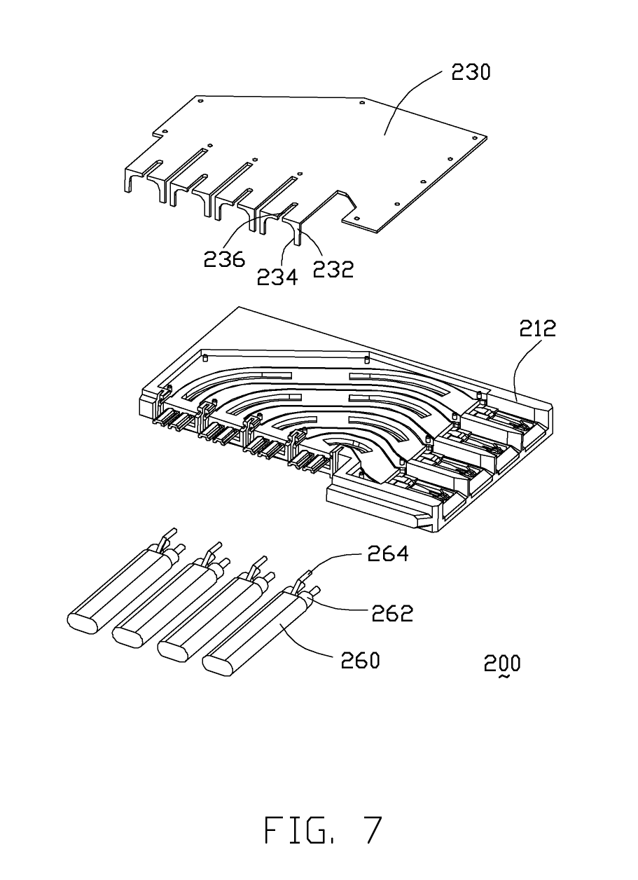

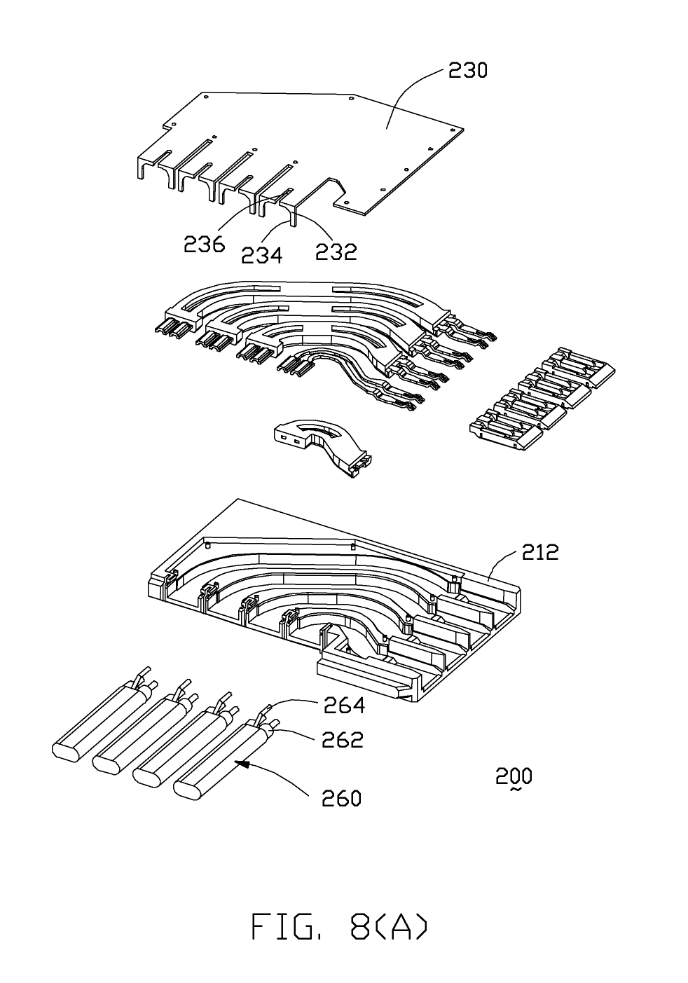

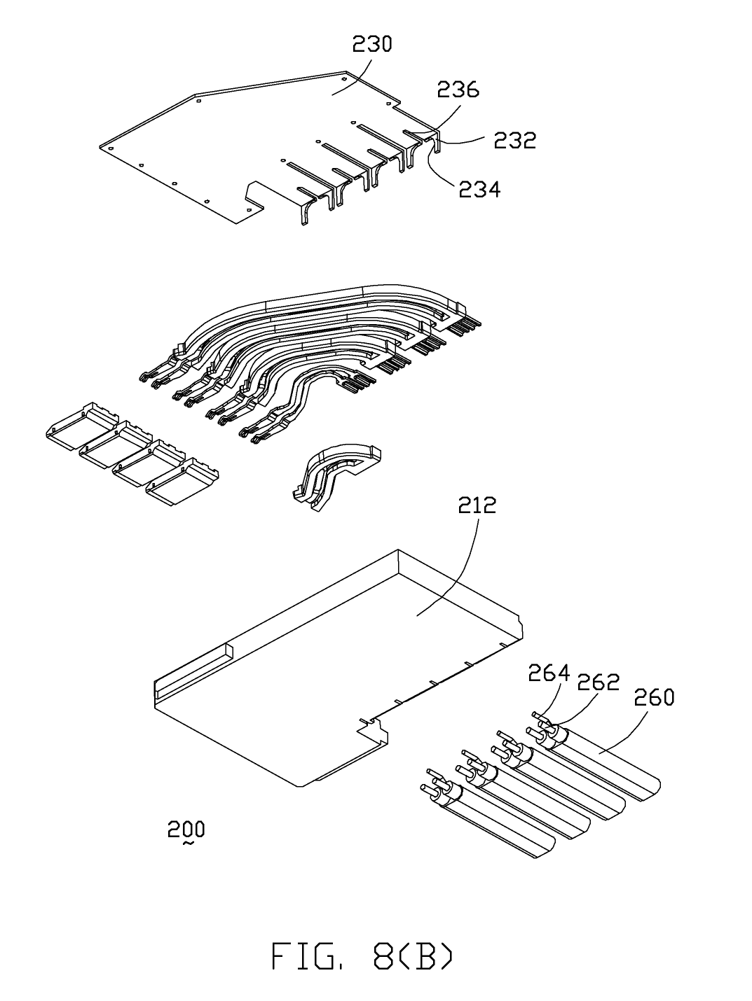

Referring to FIGS. 5(A)-8(B), the connector assembly 200 includes all similar elements with the connector assembly 1 except without the spacer. Instead, the shielding plate 230 includes a vertical section 232, as an organizer, forming a plurality of passages 234 to receive the corresponding pairs of differential wires 262 while the drain wires 264 are still received with the corresponding notches 236 of the shielding plate 230, respectively.

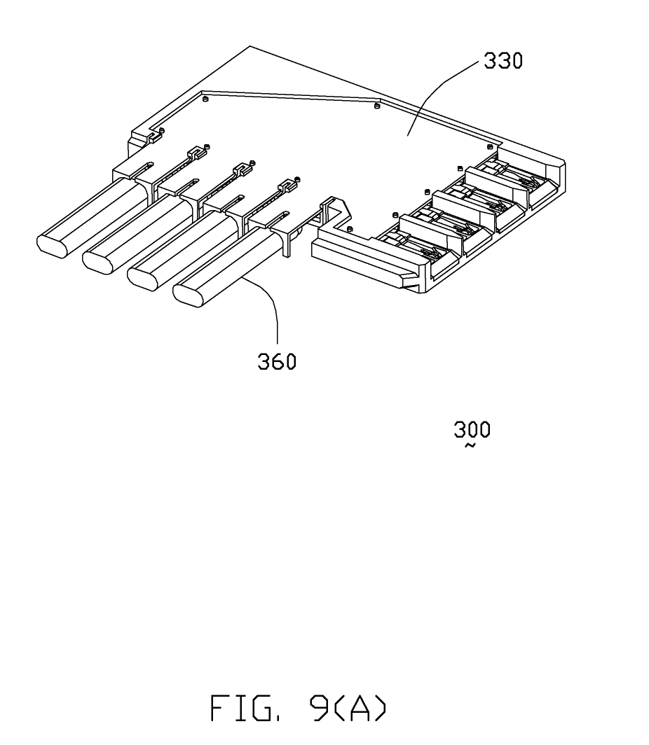

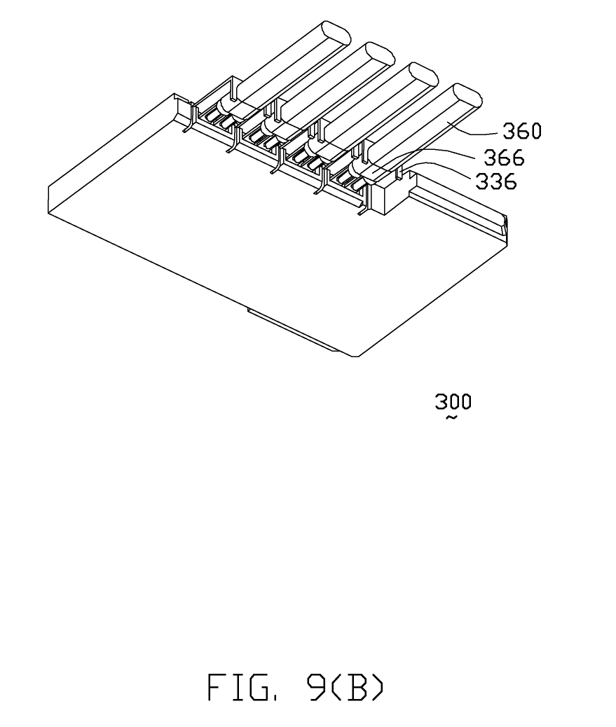

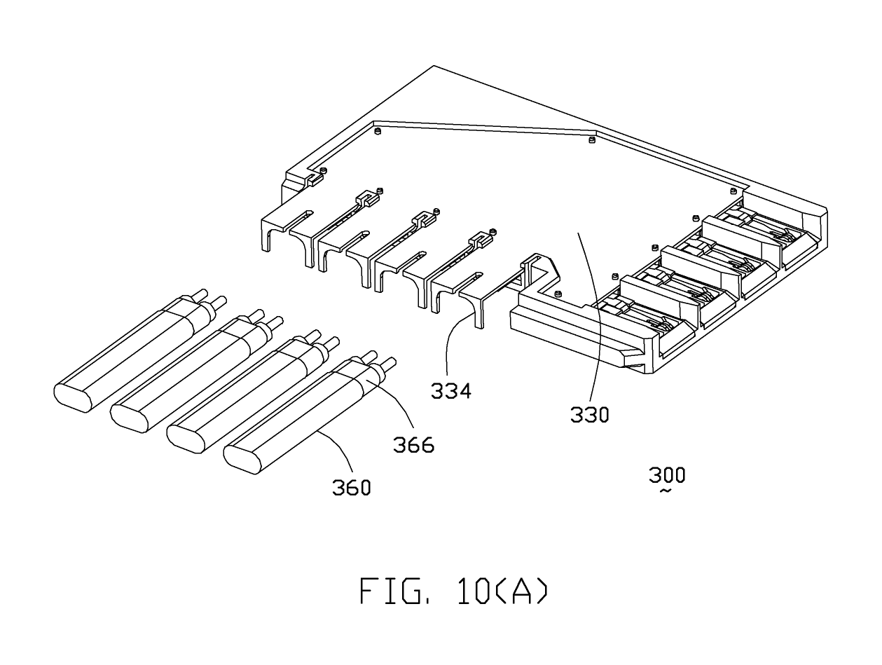

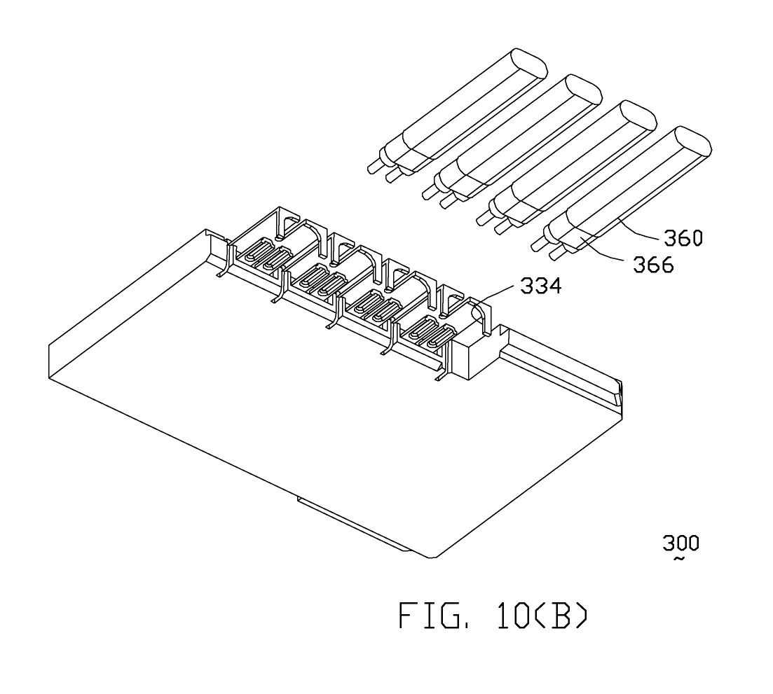

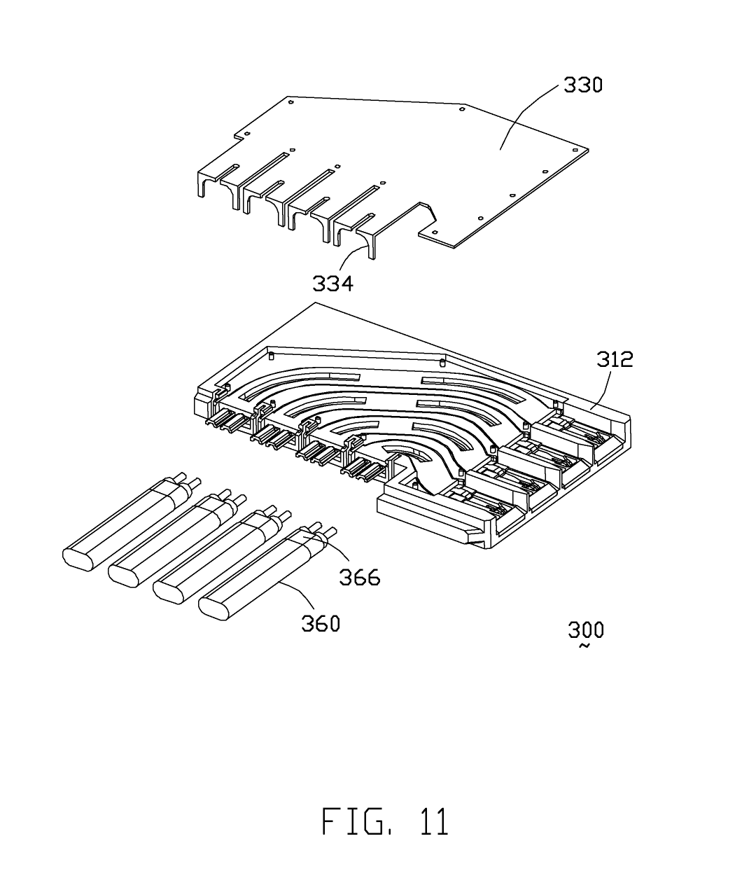

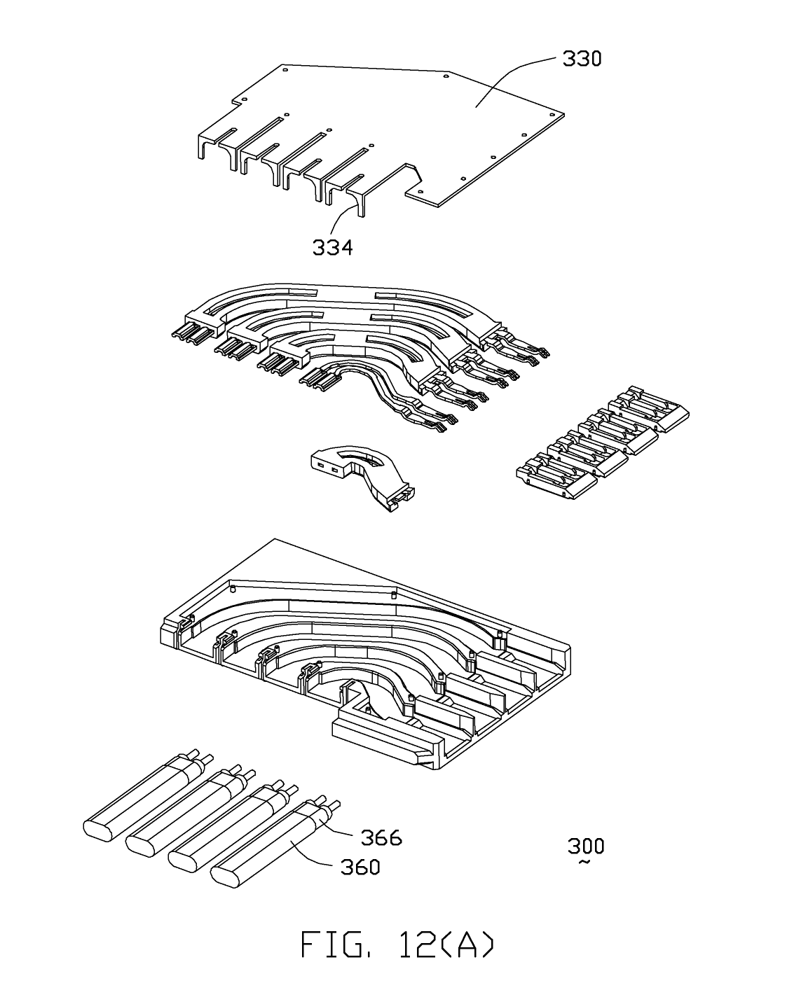

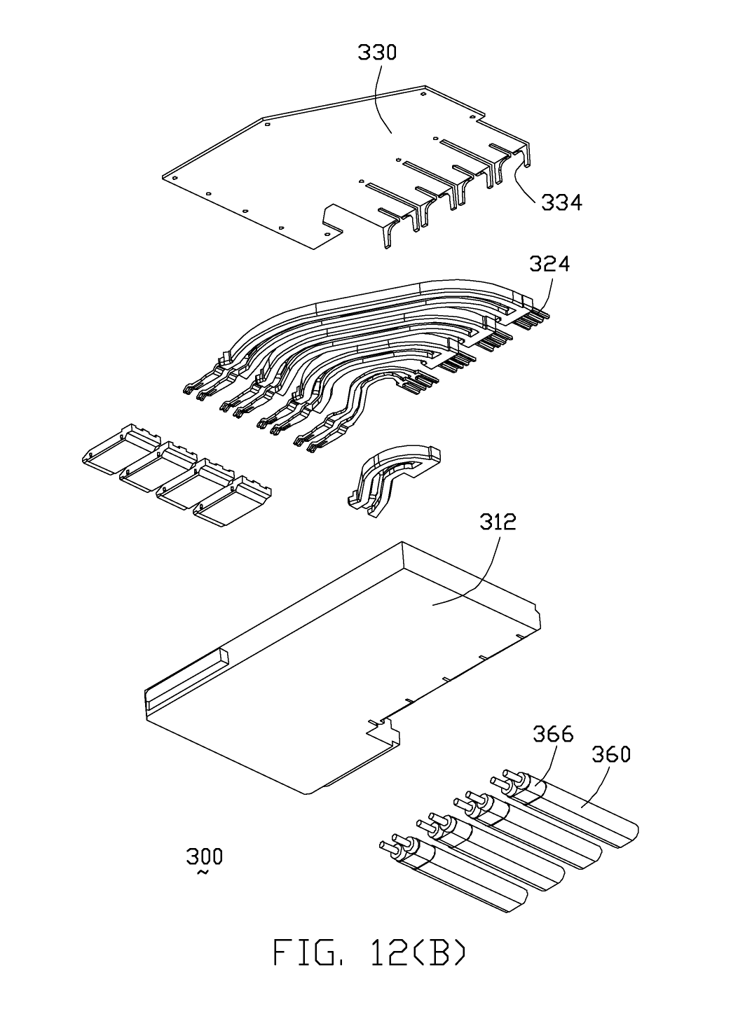

Referring to FIGS. 9(A)-12(B), the connector assembly 300 includes all similar elements with the connector assembly 200 except without the drain wire in each cable 360. Instead, the cable 360 includes a braiding layer 366 directly soldered to the shielding plate 330 around the corresponding passages 334 respectively.

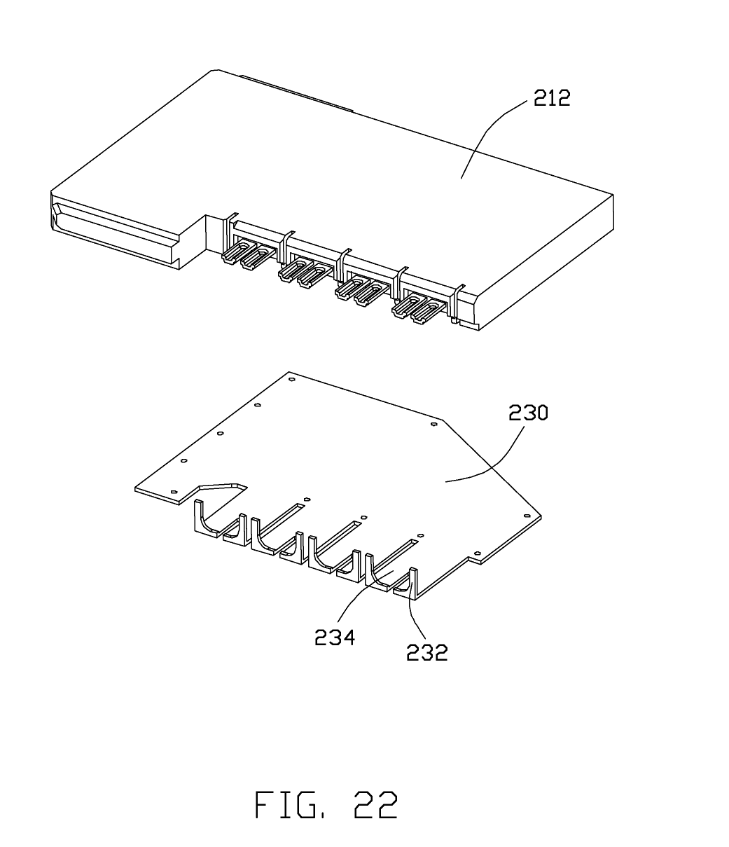

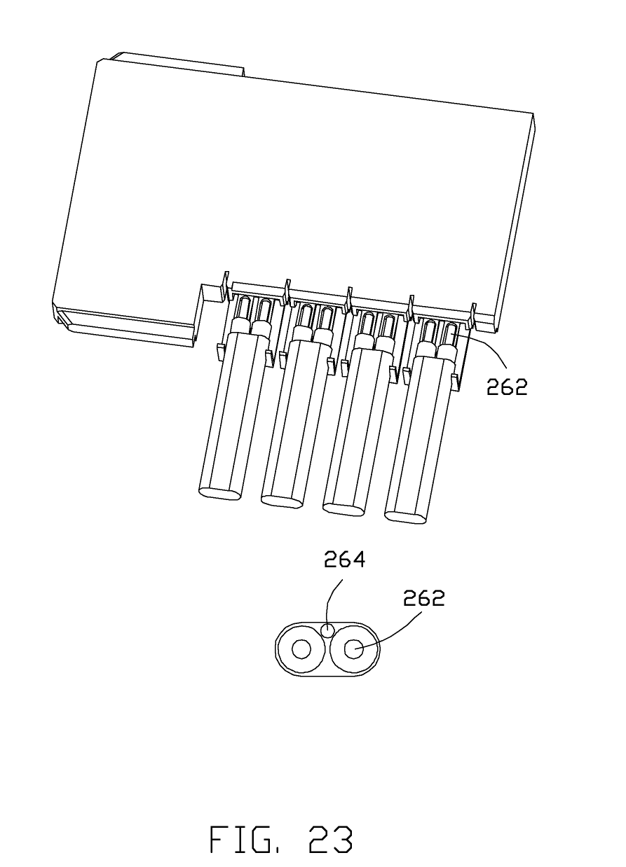

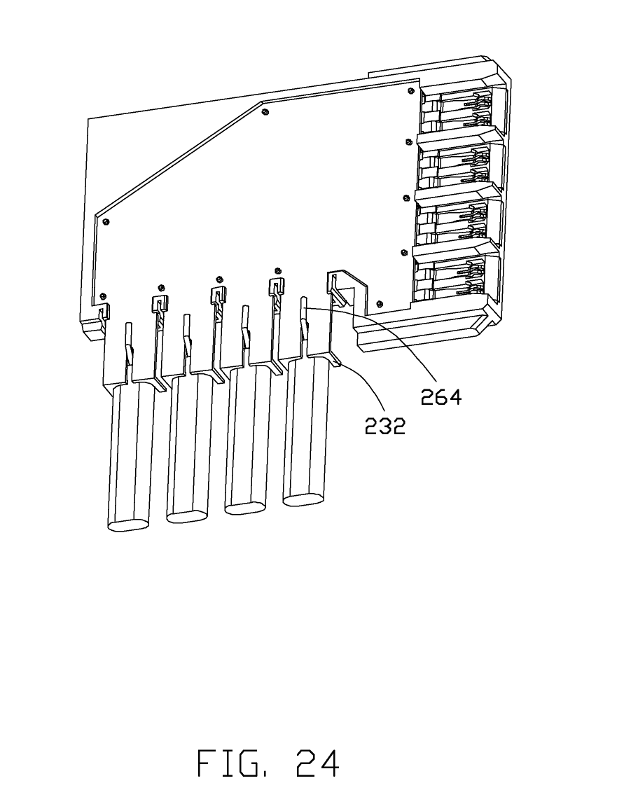

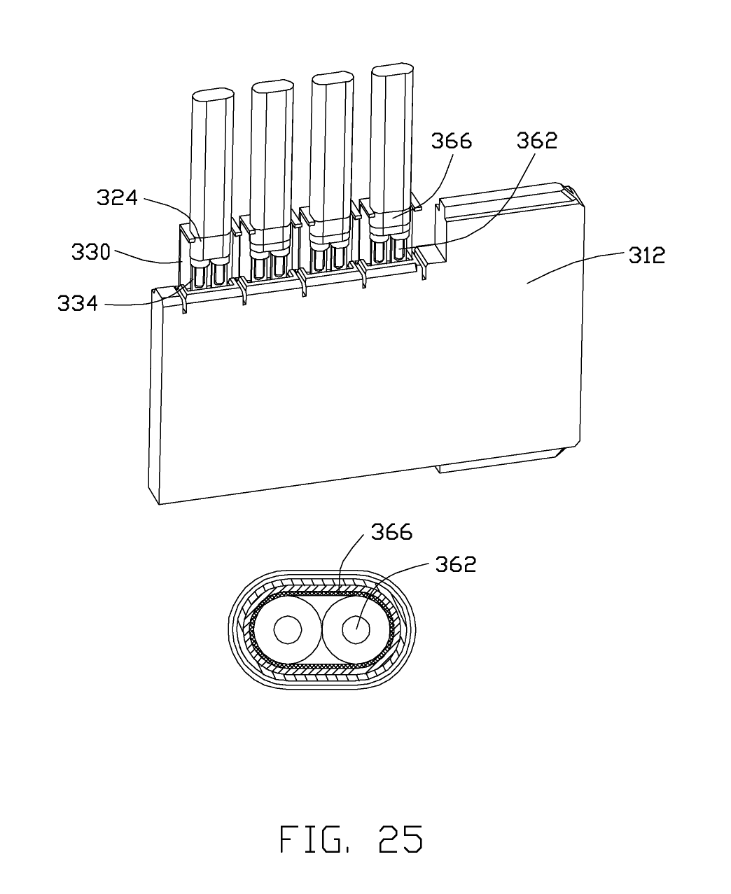

FIGS. 13-21 show the assembling steps of the first embodiment wherein FIG. 20 shows the shielding blades 40 thereof, FIGS. 22-24 show the partial assembling steps of the second embodiment, the partial assembling procedure includes:
Step 1: assembling the shielding plate 230 to the housing 212;
Step 2: assembling the corresponding pairs of differential wires 262 into the passages 234 of the vertical section 232 of the shielding plate 230;
Step 3: soldering the differential wires 262 to the rear tail sections 224; and
Step 4: soldering the drain wires 264 to the shielding plate 230.
   FIG. 25 shows the assembled figure of the third embodiment, the assembling procedure of the third embodiment includes:
Step 1: assembling the shielding plate 330 to the housing 312;
Step 2: assembling the corresponding pairs of differential wires 362 into the passages 334 of the shielding plate 330;
Step 3: soldering the differential wires 362 to the rear tail sections 324; and
Step 4: soldering the braiding layer 366 to the shielding plate.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector assembly comprising:
a plurality of wafers and a plurality of shielding plates alternately stacked with each other in a transverse direction, each of said wafers including:
a conductive housing forming a plurality of slots;
a plurality of terminal modules received within the corresponding slots, respectively, each of said terminal modules including a pair of differential contacts enclosed within an insulative holder while exposing corresponding front contacting sections and rear tail sections to an exterior; and
a plurality of cable assemblies respectively corresponding to the wafers, respectively, each of the cable assemblies including a plurality of cables respectively corresponding to the terminal modules, each of said cables including a pair of differential wires and a drain wire; wherein
the pair of differential wires are mechanically and electrically connected to the corresponding pair of differential contacts while the drain wire is mechanically and electrically connected to the neighboring shielding plate.

2. The electrical connector assembly as claimed in claim 1, wherein the shielding plate forms a plate with a plurality of passages through which the pair of differential wires extend, respectively.

3. The electrical connector assembly as claimed in claim 1, wherein said cable assembly further includes a spacer defining a plurality of passages through which the pair of differential wires extend, respectively.

4. The electrical connector assembly as claimed in claim 3, wherein the spacer further includes a plurality of recesses through which the drain wires extend, respectively.

5. The electrical connector assembly as claimed in claim 1, wherein the shielding plate forms a plurality of notches to receive the corresponding drain wires, respectively.

6. The electrical connector assembly as claimed in claim 5, further comprising a plurality of shielding blades disposed between adjacent two pair of differential wires respectively, the conductive housing forming a plurality of slits to receive the shielding blades, respectively.

7. A method of assembling an electrical connector assembly comprising steps of:
providing a wafer with a conductive housing having a plurality of slots open to an exterior in a transverse direction;
assembling a plurality of terminal modules into the corresponding slots in said transverse direction, each of said terminal modules including a pair of differential contacts retained by an insulative holder;
providing a cable assembly with a plurality of cables each including a pair of differential wires and a drain wire;
assembling a shielding plate to the wafer to cover the terminal modules and the slots in the transverse direction; and
soldering the pair of differential wires to the corresponding differential contacts, respectively, while soldering the drain wire to the shielding plate.

8. The method as claimed in claim 7, wherein said shielding plate forms a plurality of notches to receive the corresponding drain wires, respectively.

9. The method as claimed in claim 7, wherein said shielding plate forms a plurality of passages through which the cables extend, respectively.

10. The method as claimed in claim 7, wherein said cable assembly further includes a spacer forming a plurality of passages through which the cables extend, respectively.

11. The method as claimed in claim 10, wherein said spacer further includes a plurality of recesses through which the drain wires extend, respectively.

12. The method as claimed in claim 7, wherein the conductive housing forms a plurality of slits, further providing a plurality of shielding blades inserted into the slits respectively and disposed between adjacent two pair of differential wires respectively.

13. The method as claimed in claim 7, wherein the wafer, the shielding plate and the cable assembly are grouped as one unit, and a plurality of units are stacked with one another to form a plurality of wafers and a plurality of shielding plates are stacked with each other alternately in the transverse direction.

14. The method as claimed in claim 7, further applying hot glue to the solder joints.

15. An electrical connector assembly comprising:
a plurality of wafers and a plurality of shielding plates alternately stacked with each other in a transverse direction, each of said wafers including:
a conductive housing forming a plurality of slots;
a plurality of terminal modules received within the corresponding slots, respectively, each of said terminal modules including a pair of differential contacts enclosed within an insulative holder while exposing corresponding front contacting sections and rear tail sections to an exterior; and
a plurality of cable assemblies respectively corresponding to the wafers, each of said cable assemblies including a plurality of cables corresponding to the terminal modules, each of said cables including a pair of differential wires and a braiding layer surrounding the differential wires; wherein
the pair of differential wires are mechanically and electrically connected to the corresponding pair of differential contacts while the braiding layer is mechanically and electrically connected to the neighboring shielding plate.

16. The electrical connector assembly as claimed in claim 15, wherein the shielding plate forms a plurality of passages through which the corresponding cables extend, respectively.

17. The electrical connector assembly as claimed in claim 16, wherein the braiding layer is connected to a position around the corresponding passage.
